(19) United States
(12) Patent Application Publication
(10) Pub. No.: US 2004/0199437 A1
(43) Pub. Date: Oct. 7, 2004

(54) Generating and tracking value-added services

(76) Inventors: Christoph Lessmoellmann, Bad Schoenborn (DE); Orit Harel, Kadima (IL); Noam Tamarkin, Herzeliya (IL); Ami Heitner, Kfar Saba (IL); Ziv Holzman, Tel-Aviv (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/408,755

(22) Filed: Apr. 7, 2003

(51) Int. Cl. G06F 17/60

(52) U.S. Cl. 705/29

(57) ABSTRACT

A method of implementing a value-added service (VAS) in a warehouse management system includes configuring the warehouse management system by includes instructions to execute the VAS and a VAS type indicator. The method also includes, upon receiving a sales order, determining if the VAS is required for the sales order. The method further includes, if the VAS is required for the sales order, monitoring execution of the VAS for the sales order using a procedure determined to be appropriate for the VAS type for the VAS being executed.

### TECHNICAL FIELD

This application relates to management systems that include value-added services.

### BACKGROUND

Value-added services (VASs) are typically operations that are performed for managerial reasons or to increase the value of goods for a business partner. Some VASs such as tagging, marking and hanger insertion, are performed in distribution centers (DCs) and warehouses that ship to retail stores. Other VASs, such as light assembly (kitting), are performed in DCs and warehouses that process electronic or mechanical components. In general, multiple value-added services are performed in a single DC/warehouse.

Suppliers, such as third party logistics providers, invest a significant amount of effort in planning and providing value-added services to their customers.

### SUMMARY

In one aspect, the invention features a method of implementing a value-added service (VAS). The method includes configuring the warehouse management system by includes instructions to execute the VAS and a VAS type indicator. The method also includes, upon receiving a sales order, determining if the VAS is required for the sales order. The method further includes, if the VAS is required for the sales order, monitoring execution of the VAS for the sales order using a procedure determined to be appropriate for the VAS type for the VAS being executed.

In another aspect, the invention features an article. The article includes a machine-readable medium that stores executable instructions. The instructions cause a machine to configure the warehouse management system by defining the VAS prior to receiving sales orders. The VAS definition includes instructions to execute the VAS and a VAS type indicator. The instructions also cause a machine to, upon receiving a sales order, determine if the VAS is required for the sales order. The instructions further cause a machine to, if the VAS is required for the sales order, monitor execution of the VAS for the sales order using a procedure determined to be appropriate for the VAS type for the VAS being executed.

In a still further aspect, the invention features an apparatus. The apparatus includes a memory that stores executable instructions. The apparatus also includes a processor that executes the instructions to configure the warehouse management system by defining the VAS prior to receiving sales orders. The VAS definition includes instructions to execute the VAS and a VAS type indicator. The processor also executes instructions to, upon receiving a sales order, determine if the VAS is required for the sales order. The processor further executes instructions to, if the VAS is required for the sales order, monitor execution of the VAS for the sales order using a procedure determined to be appropriate for the VAS type for the VAS being executed.

Each aspect may have one of the following features. The work centers may be defined prior to receiving orders. If the VAS is required, the work center to execute the VAS may be determined. Defining a work center may include defining a work center priority. Determining the work center includes determining the work center based on the work center priority. Determining the work center may also include determining the work center based on a capacity of each work center. Determining the work center may further include synchronizing arrival times of material involved in the VAS.

The VAS type indicator may indicate changes to a material attribute of goods to which VAS are being applied. The VAS type indicator may indicate changes to a handling unit/stock unit attribute of goods to which VAS are being applied. The VAS type indicator may indicate no attribute changes to goods to which VAS are being applied.

An aspect may include excluding VAS materials from picking. Excluding may include excluding the VAS materials in work centers. Excluding may include excluding the VAS materials in transport from and to the work center. Excluding may include excluding VAS materials in semi-finished condition in stock.

An aspect may include generating a VAS execution report. The execution report may include an execution time versus a planned time of the VAS. The execution report may also include costs, resources, equipment and materials involved in the VAS execution. Executed VAS may also be billed.

Other features include executing a VAS for all sales orders attributed to a customer or executing a VAS for an individual sales order.

The aspect above may have one or more of the following advantages. The invention allows for generating, tracking and billing of value-added services in the warehouse. Thus, managers can ascertain the cost and profitability of performing value-added services within a warehouse. In addition, different work centers within a warehouse that perform VAS also can be monitored. Furthermore, value-added services performed at a handling unit level, a stock unit level or an activity level can be controlled and monitored.

### DESCRIPTION OF THE DRAWINGS

FIG. 1 is a block diagram of an order fulfillment system.

FIG. 2 is a flowchart of a process for generating value-added services.

FIG. 3 is a flowchart of a process for controlling and executing the value-added services.

FIG. 4 is an example of an execution report.

FIG. 5 is a block diagram of a computer system on which the process of FIGS. 2 and 3 may be implemented.

### DESCRIPTION

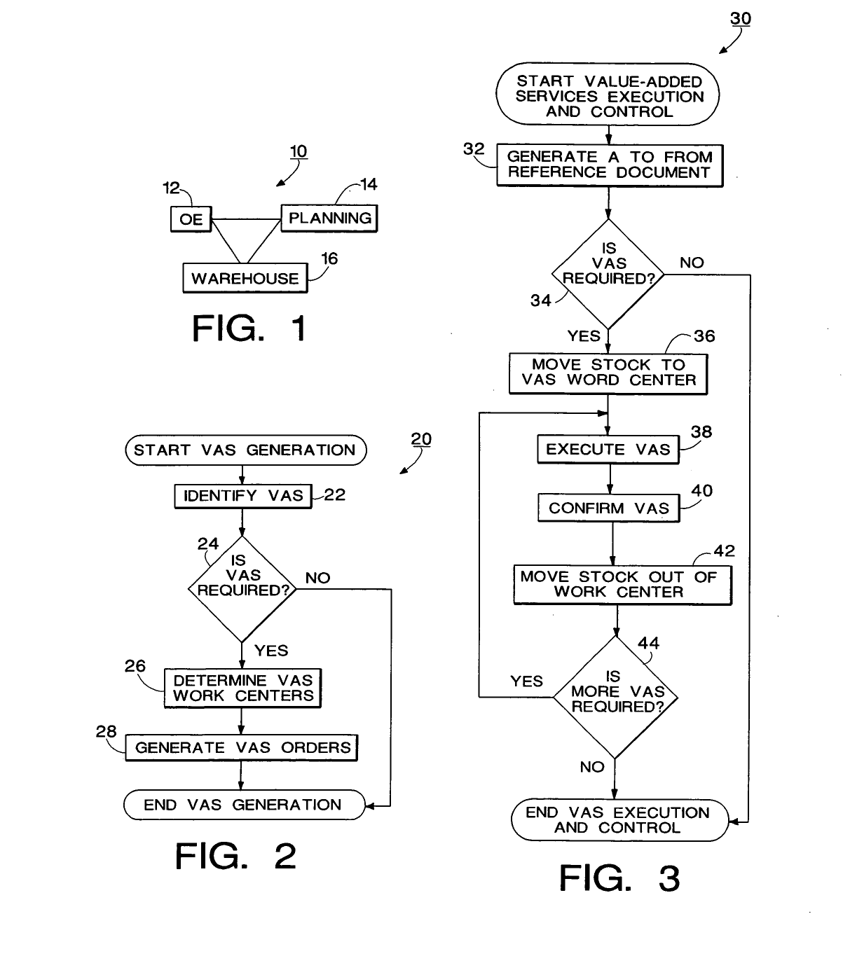

Referring to FIG. 1, an order fulfillment system 10 includes an order entry (OE) module 12, a planning module 14, and a warehouse module 16. These modules may be implemented in software one or more machines.

Order entry module 12 receives orders from customers and sends order requirements (i.e., requirements from the orders) to planning module 14. Planning module 14 ensures that sufficient product is produced in time to meet the order requirements. Resulting product is stored in one or more warehouses, from which the product may be shipped. Warehouse module 16 manages product in one or more such warehouses and generates delivery documents for shipping product from the warehouses to the customers.

As described below, warehouse module 16 executes a process 20 (FIG. 2) to generate value-added services. Warehouse module 16 also executes a process 30 (FIG. 3) to perform value-added services on products in warehouse(s) and products that are tracked externally from such warehouse(s). As will also be described, tracking the execution of value-added services is advantageous since it can result in billing customers per valued-added service.

In this embodiment, a value-added service can include one or more sequential actions. By way of example, a value-added service for gift wrapping may include the following actions: (1) insert a printed message (as written in a customer order) into a gift; (2) perform gift wrapping with green paper and a red string; (3) pack the gift in a box for shipping by mail; and (4) affix an address label to the box. In system 10, each value-added service is assigned an action list. An action list is a list of actions that are required to perform a VAS. Each action list can be pre-defined or dynamically determined, e.g., based on text in a delivery (or other) document.

Referring to FIG. 2, process 20 identifies (22) all required value-added services. Required value-added services are identified, for example, from customer requirements or other input criteria. Process 20 determines (24) if VAS are required for a specific product or for a specific customer. A determination as to whether VASs are required is based on VAS determination rules. VAS determination rules indicate if, and under what conditions, a specific VAS is required for a product or a customer order. In this embodiment, VAS determination rules are predefined by a user (e.g., a manager) and are process specific. One or more VAS rules may be stored in memory such that they are accessible to process 20.

In this embodiment, each VAS rule includes at least one condition and a result that occurs if the condition(s) is met. Conditions in a VAS rule may include one or more of the following: a delivery type (outbound or inbound good), a business partner (BP) designator defining a business partner, a BP group defining groups of business partners, a material number of a product, a material group defining groups of material numbers, a quantity of product, and a shipment route.

The result in a VAS rule can be any VAS with an assigned action list. Each condition can result in one or more results (i.e., several VAS). In the case of multiple VASs, results are sequenced to indicate the execution order of the VASS.

Each VAS includes a VAS type. The VAS type is defined by VAS type indicators in the VAS. In this embodiment, there are three VAS “types”. A first VAS type changes material attributes of a product (such as a change to the material, number and/or the quantity of product to which VASs are being applied). An example of a first VAS type is a filling operation, such as filling barrels or bottles with a liquid. The smaller barrels or bottles are handled as different materials (as opposed to a single liquid). Another example of a first VAS type is applying a promotion sticker to a number of shampoo bottles. The material on promotion is thereby distinguished from the “normal” stock. Changes made in material number and quantities are sent to planning module 14.

A second VAS type changes the handling unit (HU)/stock unit (SU) attributes. A handling unit is a physical unit comprised of packaging materials (load carrier/packaging material) and the material contained therein. The HU has a single, scannable identification number that can be used to call up the data for the handling unit.

In this embodiment, the second VAS type includes operations that relate to the warehouse. Examples of a second VAS type include packing without any material or quantity changes involved (there may be changes to the handling unit and labels). A typical example of a VAS that changes the handling unit would be a sequencing action to prepare the order of materials inside a package. For example, an automotive manufacturer has, at a certain point in a car manufacturing process, to install two side mirrors onto a car. These mirrors are prepared as pairs in the proper order within layers of the handling unit. Thus, the mirrors are available to an assembly belt at the right point in time for the right car and for the sequence of planned cars.

In this embodiment, a third VAS type includes operational actions that have no product attribute changes. For example, the third VAS type may include printing documents or labels or may include shrink-wrapping a pallet for outbound delivery.

Referring back to FIG. 2, process 20 determines if a VAS is required. If VAS is required, process 20 determines (26) VAS work centers for all required VAS, otherwise process 20 ends. In this embodiment, a work center is a physical location where the VAS is performed. The same VAS can be performed simultaneously at many workstations. Thus, there may be multiple work centers in a single system. A sequence of VAS actions can also be passed through many subsequent work centers. However, a VAS can also be performed at only one work center. In addition, more than one VAS for a specific document could be performed in the same work center.

Work centers may be configured as storage locations to enable stock visibility and service updating. However, a storage location for VAS is excluded for picking to ensure material will not be picked prior to the VAS execution. Picking, in this context, may refer to physically removing material to fulfill material requirements such as a bill of a material. Thus, system 10, through, for example, warehouse module 16, distinguishes items in stock where no VAS was executed, and items where the VAS was executed. This includes excluding (1) the VAS materials in work centers; (2) the VAS materials in transport from and to a work center; and (3) the VAS materials in semifinished condition in stock. In addition, VAS material may be excluded through attribute changes (e.g., changes in material, batch, handling unit, storage unit and quantity-related attributes).

In this embodiment, the work center may be defined by a system administrator, warehouse manager, or any user having the authorization to define the work center. Each work center definition includes a work center identifier, a physical location, the VAS that can be executed at that work center, and/or the average duration for VAS execution per VAS order and per instruction level.

Since a VAS can be executed in more than one work center, a manager can prioritize work centers. Selection of a work center is based on (1) whether a VAS can be executed at the work center, (2) if the VAS can be executed at the work center, does the work center have priority over other work centers, (3) the lowest average time duration to perform the VAS over other work centers, (4) the shortest measured distance from the source, a “pick from” location, for example, to a destination such as the work center, (5) current capacity constraints, which the VAS is performed or scheduled currently on which work center, and (6) a sequence of instructions in a VAS referring to the sequence of work centers.

Process 20 generates (28) a VAS order at its conclusion.

Referring to FIG. 3, process 30 generates (32) a transfer order (TO) using a reference document. A transfer order defines movement of material from one location to another. A reference document is a document from which data is copied in order to create a request to move material (i.e., a TO).

Process 30 determines (34) if a VAS is required. If a VAS is not required, process 30 ends. If it is determined that VAS rules apply, VAS requirements are determined by document (delivery) properties. The VAS “type” defines the VAS requirements. In the first VAS type, no special rules are predefined. Make-to-Stock (MTS) requirements may be initiated manually based on inventory and expected demand. Make-to-Order (MTO) requirements are explicitly requested by a sales order.

In the second VAS type, VAS requirements are a combination of business processes and/or various material and business partner attributes. Business partners are, for example, not limited to vendor/supplier, logistics service providers, ship to/sold to customers, owner of goods, occupant of goods or any combination thereof. VAS requirements could be also dependant on room conditions, external and internal routes, shipment conditions, export/import requirements, transporting and loading combinations with other materials. VAS requirements for inbound material (to the warehouse) could be material specific and VAS requirements for outbound material could be customer specific.

In the third VAS type, VAS requirements can be a combination of a business process and/or various material and business partner attributes or any combination of the elements described hereinabove.

If VAS is required, process 30 moves (36) stock to the VAS work center by executing another transfer order (TO) to move stock into the work center. If many different items arrive at a particular work center at the same time, system 10 ensures that all components of a VAS order are directed to the relevant work center simultaneously. The transfer orders are a picking/putaway (stocking) transfer order that gets assigned a new destination due to the VAS activity.

Process 30 executes (38) VAS at the work center by using a resource (e.g., a worker). System 10 provides the resource with the action list to perform the VAS. The resource can be one or more persons that follow the action list. In other embodiments, the resource can be machine-executable instructions, to perform the VAS.

Process 30 confirms (40) VAS execution based on the VAS type. A VAS having the first VAS type may be tracked by using its material number so that any changes in its material number indicate a VAS execution. A VAS having a second VAS type may be tracked implicitly by stock location changes and/or by tracing executed activities. Executed activities may include a transfer order confirmation, VAS transaction utilization, etc. A VAS having a third VAS type may be tracked by VAS executions implicitly by execution activity.

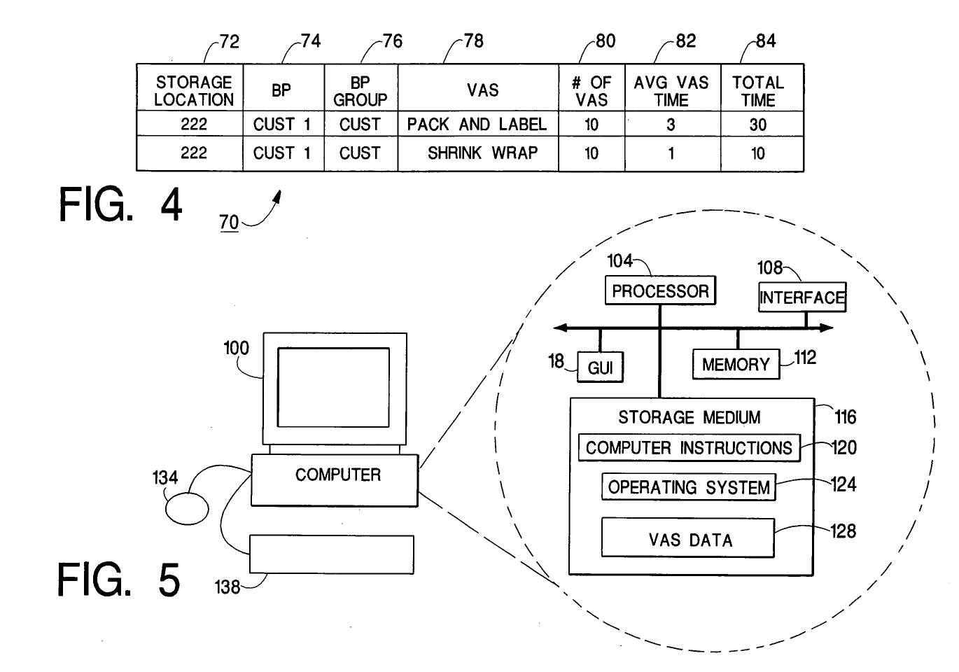

FIG. 4 shows a VAS execution report 70 that is generated to record VAS execution. Execution report 70 includes a storage location 72, a business partner (BP) code 74, a BP group code 76, a VAS identifier 78, a number of VAS executions 80, an average time per VAS 82, and the total time spent on a VAS 84. Other systems (not shown) may use VAS execution reports to generate billing reports for managers to track costs and to bill internal or external customers accordingly. Execution reports may also include resources, equipment and materials involved in VAS execution. For example, a report may include resource productivity such as an execution time of a VAS versus a planned time of the VAS.

Other types of reports may be generated by process 30. For example, system 10 may include stored pricing, margin, rebate and surcharge data per VAS activity and per material. Thus, process 30 may generate reports to customers on pricing information.

Process 30 moves (42) stock out of the work center by generating a TO. Process 30 determines (42) if more VAS are required to be executed.

FIG. 5 shows a computer 100 for performing a VAS using processes 20 and/or 30. Computer 100 includes a processor 104, an interface 108, a graphical user interface (GUI) 110, a memory 112, and a storage medium 116 (e.g., hard disk). Storage medium 116 stores operating system 124, VAS data 128 for VAS processing, and machine-executable instructions 120 which are executed by processor 104 out of memory 112 to perform process 20. VAS data 128 may include, but are not limited to, VAS determination rules, work center definitions, VAS definitions and work center priorities. VAS data may also include, but are not limited to, pricing, margins, rebates, surcharges per VAS activity and per material. VAS data 128 may be loaded by a user via GUI 110 and a keyboard 138 or a mouse 134.

Processes 20 and 30 are not limited to use with the hardware and software of FIG. 5; they may find applicability in any computing or processing environment and with any type of machine that is capable of running a computer program. Processes 20 and 30 may be implemented in hardware, software, or a combination of the two. For example, processes 20 and 30 may be implemented in a circuit that includes one or a combination of a processor, a memory, programmable logic and logic gates. Processes 20 and 30 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processes 20 and 30 and to generate output information.

Each such program may be implemented in a high level procedural or object-oriented programming language to communicate with a computer system. However, the programs can be implemented in assembly or machine language. The language may be a compiled or an interpreted language. Each computer program may be stored on a storage medium or device (e.g., CD-ROM, hard disk, or magnetic diskette) that is readable by a general or special purpose programmable computer for configuring and operating the computer when the storage medium or device is read by the computer to perform processes 20 and 30. Processes 20 and 30 may also be implemented as a machine-readable storage medium (or media), configured with a computer program (or programs), where, upon execution, instructions in the computer program cause the computer to operate in accordance with processes 20 and 30.

Processes 20 and 30 are not limited to the specific embodiments described herein. For example, the processes may include inbound VAS activities as well outbound VAS activities. Inbound VAS activities may be performed as part of an inbound receiving process. Inbound VAS activities may include storing material safely, performing special packaging, ensuring material is rust-free, protecting material from theft, providing additional tags or radio frequency identification (RFID) labels or requiring material to be serviced, overhauled, painted, greased, or coated with dust protection before the material is stored. In addition, the processes may be used in service parts logistics.

In other examples, processes 20 and 30 may be used on master documents for a customer. For example, all orders from a customer may receive the same VAS for all sales orders. In other examples, VAS may be determined per individual sales order. Therefore, instead of having a master data file, a one-time instruction list is associated with a single sales order.

In other examples, processes 20 and 30 may be executed wholly or in part by logistic service providers. The processes may include further actions to split stock movement activities by sending VAS material to a logistics service provider, to execute the VAS at the logistics service provider, and to forward the goods to a final recipient (e.g., a customer). Other actions include triggering an inventory update and sending shipping and invoicing documents to the final recipient. Further actions include invoicing the VAS. Still further actions include provisioning, at the logistics service provider, high demand parts or packaging materials.

Processes 20 and 30 are not limited to the specific processing order of FIG. 2 or FIG. 3. Rather, the blocks of FIGS. 2 and 3 may be re-ordered, as necessary, to achieve the results set forth above.

Other embodiments not described herein are also within the scope of the following claims.

What is claimed is:

1. A method of implementing a value-added service (VAS) in a warehouse management system, comprising:
configuring the warehouse management system by defining the VAS prior to receiving sales orders, the VAS definition comprising instructions to execute the VAS and a VAS type indicator;
upon receiving a sales order, determining if the VAS is required for the sales order; and
if the VAS is required for the sales order, monitoring execution of the VAS for the sales order using a procedure determined to be appropriate for the VAS type for the VAS being executed.

2. The method of claim 1, further comprising:
defining work centers prior to receiving sales orders.

3. The method of claim 2, further comprising:
if the VAS is required, determining a work center to execute the VAS.

4. The method of claim 1 wherein the VAS type indicator indicates changes to a material attribute of goods to which VAS are being applied.

5. The method of claim 1 wherein the VAS type indicator indicates changes to a handling unit/stock unit attribute of goods to which VAS are being applied.

6. The method of claim 1 wherein the VAS type indicator indicates no attribute changes to goods to which VAS are being applied.

7. The method of claim 1, further comprising:
billing executed VAS.

8. The method of claim 3, wherein defining a work center comprises defining a work center priority.

9. The method of claim 8, wherein determining the work center comprises determining the work center based on work center priority.

10. The method of claim 3, wherein determining the work center is based on a capacity of each work center.

11. The method of claim 3, wherein determining the work center is based on a combination of business processes, material attributes and business partner attributes.

12. The method of claim 3, wherein determining the work center comprises synchronizing arrival times of material involved in the VAS.

13. The method of claim 1, further comprising excluding VAS materials from picking.

14. The method of claim 13 wherein excluding comprises:
excluding the VAS materials in work centers;
excluding the VAS materials in transport from and to the work center; and
excluding VAS materials in semi-finished condition in stock.

15. The method of claim 1, further comprising:
generating a VAS execution report.

16. The method of claim 15, wherein the VAS execution report comprises:
an execution time and a planned time of the VAS.

17. The method of claim 15 wherein the execution report comprises:
costs, resources, equipment and materials involved in VAS execution.

18. The method of claim 1, wherein the VAS is defined for all sales orders attributed to a customer.

19. The method of claim 1, further comprising defining a VAS for an individual sales order.

20. The method of claim 1, wherein the VAS is performed on outgoing goods.

21. An article comprising:
a machine-readable medium that stores executable instructions, the instructions causing a machine to:
configure the warehouse management system by defining the VAS prior to receiving sales orders, the VAS definition comprising instructions to execute the VAS and a VAS type indicator;
upon receiving a sales order, determine if the VAS is required for the sales order; and
if the VAS is required for the sales order, monitor execution of the VAS for the sales order using a procedure determined to be appropriate for the VAS type for the VAS being executed.

22. The article of claim 21, further comprising instructions causing a machine to:
define work centers prior to receiving sales orders.

23. The article of claim 22, further comprising causing a machine to:
if the VAS is required, determine a work center to execute the VAS.

24. The article of claim 21, wherein the VAS type indicator indicates changes to a material attribute of goods to which VAS are being applied.

25. The article of claim 22, wherein the type indicator indicates changes to a handling unit/stock unit attribute of goods to which VAS are being applied.

26. The article of claim 21, wherein the type indicator indicates no attribute changes to goods to which VAS are being applied.

27. The article of claim 21, further comprising causing a machine to:
bill executed VAS.

28. The article of claim 23, wherein defining a work center comprises defining a work center priority.

29. The article of claim 28, wherein determining the work center comprises determining the work center based on work center priority.

30. The article of claim 23, wherein determining the work center is based on a capacity of each work center.

31. The article of claim 23, wherein determining the work center is based on a combination of business processes and material and business partner attributes.

32. The article of claim 23, wherein determining the work center comprises synchronizing the times of material involved in the VAS.

33. The article of claim 31, further comprising instructions causing a machine to exclude VAS materials from picking.

34. The article of claim 33, wherein excluding comprises instructions causing a machine to:
excluding the VAS materials in work centers;
excluding the VAS materials in transport from and to the work center; and
excluding VAS materials in semi-finished condition in stock.

35. The article of claim 21, further comprising instructions causing a machine to generate a VAS execution report.

36. The article of claim 35, wherein the Vas execution report comprises:
an execution time and a planned time of the VAS.

37. The article of claim 35, wherein the execution report comprises:
costs, resources, equipment and materials involved in VAS execution.

38. The article of claim 21, wherein the VAS is executed for all sales orders attributed to a customer.

39. The article of claim 21, wherein the VAS is executed for an individual sales order.

40. The article of claim 21, wherein the VAS is performed on outgoing goods.

41. An apparatus comprising:
a memory that stores executable instructions; and
a processor that executes the instructions to:
configure the warehouse management system by defining the VAS prior to receiving sales orders, the VAS definition comprising instructions to execute the VAS and a VAS type indicator;
upon receiving a sales order, determine if the VAS is required for the sales order; and
if the VAS is required for the sales order, monitor execution of the VAS for the sales order using a procedure determined to be appropriate for the VAS type for the VAS being executed.

42. The apparatus of claim 41, further comprising instructions to:
define work centers prior to receiving sales orders.

43. The apparatus of claim 41, further comprising instructions to:
if the VAS is required, determine the work center to execute the VAS.

44. The apparatus of claim 41, wherein the type indicator indicates changes to a material attribute of goods to which VAS are being applied.

45. The apparatus of claim 41, wherein the type indicator indicates changes to a handling unit/stock unit attribute of goods to which VAS are being applied.

46. The apparatus of claim 41, wherein the type indicator indicates no attribute changes to goods to which VAS are being applied.

47. The apparatus of claim 41, further comprising instructions to:
bill executed VAS.

48. The apparatus of claim 43, wherein defining a work center comprises defining a work center priority.

49. The apparatus of claim 48, wherein determining the work center comprises determining the work center based on work center priority.

50. The apparatus of claim 43, wherein determining the work center is based on a capacity of each work center.

51. The apparatus of claim 43, wherein determining the work center is based on a combination of business processes and material and business partner attributes.

52. The apparatus of claim 43, wherein determining the work center comprises synchronizing arrival times of material involved in the VAS.

53. The apparatus of claim 51, further comprising instructions to exclude VAS materials from picking.

54. The apparatus of claim 53, wherein instructions to exclude comprises:
excluding the VAS materials in work centers;
excluding the VAS materials in transport from and to the work center; and
excluding VAS materials in semi-finished condition in stock.

55. The apparatus of claim 41, further comprising instructions to:
generate a VAS execution report.

56. The apparatus of claim 55, wherein the VAS execution report comprises:
an execution time and a planned time of the VAS.

57. The apparatus of claim 55, wherein the execution report comprises:
costs, resources, equipment and materials involved in VAS execution.

58. The apparatus of claim 41, wherein the VAS is executed for all sales orders attributed to a customer.

59. The apparatus of claim 41, wherein the VAS is executed for an individual sales order.

60. The apparatus of claim 41, wherein the VAS is performed on outgoing goods.
